(19) United States
(12) Patent Application Publication
(10) Pub. No.: US 2026/0232084 A1
(43) Pub. Date: Aug. 13, 2026

(54) BELT TONGUE, MANUFACTURING METHOD, AND SEAT BELT SYSTEM

(71) Applicant: Autoliv Development AB, Vargarda (SE)

(72) Inventor: Roald LINGBEEK, Hamburg (DE)

(21) Appl. No.: 19/160,341

(22) PCT Filed: Feb. 26, 2024
(86) PCT No.: PCT/EP2024/054742

§ 371 Date: Aug. 27, 2025

(30) Foreign Application Priority Data
Feb. 28, 2023 (DE) 102023104926.7

(51) Int. Cl. A44B 11/25

(52) U.S. Cl. CPC A44B 11/2561

(57) ABSTRACT

The invention relates to a belt tongue for a seat belt, the belt tongue comprising a main body made of metal, and the main body comprising an insertion portion and a belt fastening portion. The main body has an enamel coating at least in the insertion portion. The invention further relates to a method for manufacturing a belt tongue and to a corresponding seat belt system having a belt buckle.

The present invention relates to a belt tongue for a safety belt in a ve-hicle according to the preamble of claim 1, to a method for producing a belt tongue according to the preamble of claim 9 and to a safety belt system according to the preamble of claim 15.

The belt tongues of safety belts are subjected to frequent insertion and removal processes during operation, placing significant stress on the surface of the insertion portion of the belt tongue, which is inserted and removed from the corresponding buckle. Therefore, high demands are placed on protecting the surfaces of the belt tongues or main bodies, in particular the insertion portions, from scratches and abrasion. Accordingly, belt tongues of the prior art are usually provided with a nickel-chromium coating.

However, the application of nickel-chromium coatings is very energy-intensive and uses chemicals that are difficult to handle properly. In addition, recycling used belt tongues with nickel-chromium coatings is complex.

Furthermore, the main bodies of the belt tongues are usually made of hardenable steel, for example C60, in order to achieve, among other things, the required crash strength and sufficient wear resistance.

The object of the present invention is to provide a belt tongue and a safety belt system that are free of chrome-nickel coatings and have sufficient durability at low cost. Furthermore, the object is to provide a method for producing such a belt tongue.

The object is achieved by the features of the independent claims. Further preferred developments can be taken from the dependent claims, the figures and the associated description.

In order to achieve the object, a belt tongue for a safety belt is proposed, the belt tongue having a main body made of metal, in particular steel, the main body having an insertion portion and a belt fastening portion. It is proposed that the main body has an enamel coating at least in the insertion portion.

An enamel coating, also known as vitreous enamel, is a glass-like coating that provides wear and abrasion resistance to the surface. The usual firing process for an enamel coating is carried out at temperatures at which steel is usually annealed, thus avoiding the application of an enamel coating to highly stressed steel parts in the prior art. In addition, an enamel coating typically does not achieve the surface hardness of nickel-chromium coatings, so enamel coatings are not considered for surfaces such as the insertion region of a belt tongue, which are subject to very high demands. Furthermore, the enamel coating can provide good corrosion protection for the main body of the belt tongue. In advantageous embodiments, the entire surface of the main body of the belt tongue has an enamel coating. The enamel coating eliminates the need for nickel-chromium coatings on the belt tongue, making the belt tongue significantly more environmentally friendly during production and recycling.

In addition, the enamel coating allows the belt tongue to be colored, which is not possible with a nickel-chromium coating. The belt tongue, in particular the insertion region, can therefore be any color, for example black, blue, white or orange. This also makes it possible for the belt tongue, in particular the insertion region, to be a color with a shimmering or glass effect.

The insertion portion of a belt tongue is in principle the part of a belt tongue which is intended to be inserted into a slot of a belt buckle and locked there. When the belt tongue is inserted, the belt fastening portion is located outside the corresponding belt buckle. A safety belt can be connected to the belt tongue at the belt fastening portion, which in a typical design can be achieved, for example, using an eyelet for the safety belt.

In a preferred embodiment, the main body has rounded edges, at least in the insertion portion. Preferably, the rounded edges have a radius of at least 0.2 mm. This can prevent unwanted chipping of the enamel coating at the edges during operation. Furthermore, a more uniform thickness of the enamel coating can be achieved.

According to a further development, it is proposed that the enamel coating is prestressed, preferably thermally, with residual stresses. The enamel coating is therefore preferably prestressed similarly to safety glass, so that increased compressive residual stresses are present in the enamel coating. The prestressed enamel coating can thus achieve increased wear resistance, so that the disadvantages in terms of hardness compared to a typical nickel-chromium coating can be largely compensated for.

In advantageous embodiments, the main body is made of hardened steel. The hardenable steel is preferably quenched and tempered steel, e.g. C60. This makes it possible to achieve the required breaking load values for the belt tongue. In preferred embodiments, the strength of the hardened steel of the main body is not reduced by the enamel coating, so that the belt tongue achieves the required breaking load values even with the applied enamel coating. Coating high-carbon steel is unusual, as the formation of carbon dioxide from the silicon dioxide of the enamel coating, enamel slurry or enamel paste and the carbon in the steel can lead to undesirable blistering in the enamel coating.

According to a further development, it is proposed that the main body has a bainite structure, at least on the surface beneath the enamel coating. This makes it possible to reduce residual stresses in the main body, in particular on the surface beneath the enamel coating. This makes it possible to achieve greater toughness. Bainite structure is also known as intermediate structure.

Preferably, the enamel coating has a thickness of less than 100 μm, more preferably less than 50 μm, for example 25 μm.

In other possible embodiments, the enamel coating contains friction-reducing additives. This can further increase the wear resistance of the enamel coating.

In advantageous embodiments, the belt fastening portion of the main body is overmolded with a plastics body. In possible embodiments, an enamel coating is arranged between the plastics body and the insertion portion. In alternative embodiments, there is no enamel coating between the plastics body and the insertion portion.

Furthermore, in order to achieve the object of the invention, a method for producing a belt tongue with an enamel coating on a main body or any of claims 1 to 8 is proposed comprising the steps of:
a) providing a main body of the belt tongue
b) applying enamel paste to the main body
c) heating the main body and the enamel paste
d) forming an enamel coating on the main body
e) quenching the main body with the enamel coating formed.

Before step a), the main body is preferably punched from a sheet metal and then deburred. Deburring is preferably carried out such that the main body has rounded edges. It is also possible to machine the edges of the main body in order to round them. The main body of the belt tongue is preferably made of hardenable steel and is further preferably provided in the unhardened state in step a).

The enamel paste, which is, for example, a suspension containing glass particles, is applied at least to the insertion portion of the main body. Enamel paste can also be applied to the belt fastening portion.

The enamel paste on the main body is preferably dried. Drying can take place before and/or during heating in step c).

The heating in step c) can take place, for example, in an oven. In an advantageous method, the main body is heated with the enamel paste induc-tively, which allows for very rapid and efficient heating.

Preferably, the heating in step c) takes place to more than 800° C., preferably 850° C. Furthermore, the heating in step c) preferably takes place to a temperature above the melting point of the enamel (glass) and above the austenitizing temperature of the steel.

As a result of the temperature influence in step c), the enamel coating is formed from the enamel paste in step d). Preferably, the steel of the belt tongue is austenitized at the same time. This allows the necessary step for hardening the main body to take place simultaneously with the formation of the enamel coating on the main body. This means that one heating operation can be used for two different processes.

Furthermore, the belt tongue with the enamel coating is quenched in step e), so that the main body is preferably hardened. In advantageous embodiments, the formation of the enamel coating and the hardening of the main body can take place in a single operation, allowing the production of the belt tongue to be carried out in a particularly environmentally friendly and economical manner.

In a preferred embodiment, it is proposed that the quenching in step e) takes place in a bath with a temperature between 250° C. and 400° C. According to a further development, it is proposed that the quenching in step e) takes place in a salt bath.

Quenching to this temperature range allows for hardening of the main body of the belt tongue, while at the same time preventing the enamel coating from flaking off the main body. Preferably, the enamel coating is thermally prestressed by quenching to this temperature range to such an extent that increased wear resistance of the surface of the belt tongues is achieved, at least in the insertion region. Thermal prestressing increases the crack resistance of the enamel coating, thus increasing the durability of the belt tongue. At the same time, an advantageous bainite structure can be achieved in the main body made of hardenable steel, e.g. C60.

Accordingly, during quenching in step e), the main body is preferably hardened and more preferably a thermal pretension in the enamel coating is brought about. Quenching the resulting enamel coating from temperatures exceeding 800° C., preferably 850° C., to temperatures between 250° C. and 400° C., preferably in a salt bath, not only thermally prestresses the enamel coating with the associated residual compressive stresses, but also ensures particularly good adhesion to the main body.

According to a further development, it is proposed that the heating in step c) takes place under a protective gas atmosphere. This can prevent the formation of carbon dioxide on the main body, in particular a main body made of a high-carbon, hardenable steel, which further suppresses blistering in the enamel coating during its production. This allows the enamel coating to be applied to a belt tongue with a high carbon content, which is avoided due to the formation of carbon dioxide and possible blistering in the enamel coating.

Furthermore, in order to achieve the object of the invention, a safety belt system with a belt tongue according to any of claims 1 to 8 and a belt buckle is proposed. The belt buckle, in the contact region for the insertion portion of a belt tongue, at least partially has a wear layer having zinc particles in a plastics matrix having a thickness of at least 10 μm.

This can further increase the durability and wear resistance of the safety belt system and the surface of the insertion region of the belt tongue. The wear layer having zinc particles in a plastics matrix in the belt buckle is softer than the enamel coating of the belt tongue and wears out upon contact with the belt tongue. This can reduce wear on the belt tongue that is visible to the user. The increased layer thickness of the wear layer of zinc particles, preferably zinc flakes, in a plastics matrix, preferably epoxy matrix, makes it possible to increase the number of possible cycles until the wear layer wears out. This further compensates for the disadvantages of the enamel coating compared to a conventional nickel-chromium coating in terms of lower hardness. Contact between the enamel coating and the metal parts in the contact region of the buckle can therefore be delayed for a significantly longer period.

The invention is explained below using preferred embodiments with reference to the accompanying figures. In the figures:

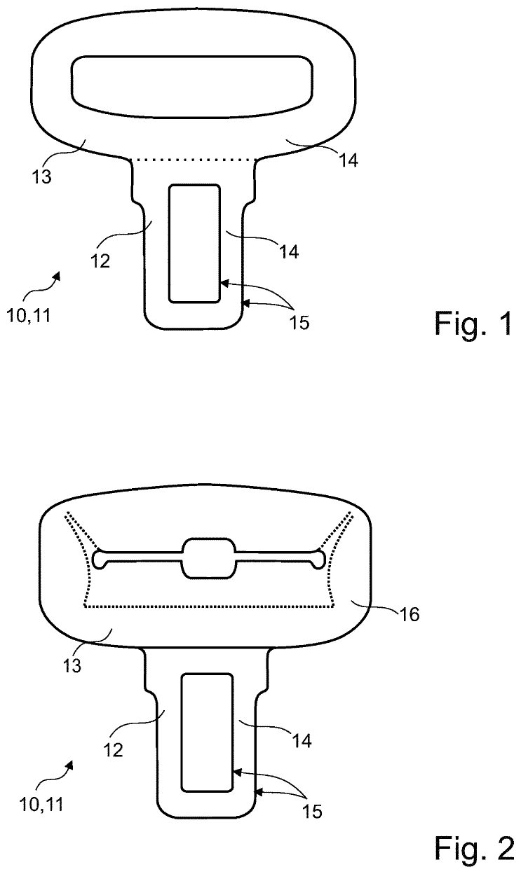

FIG. 1 shows a belt tongue with an enamel coating;

FIG. 2 shows a belt tongue with an enamel coating and an overmolded belt fastening portion;

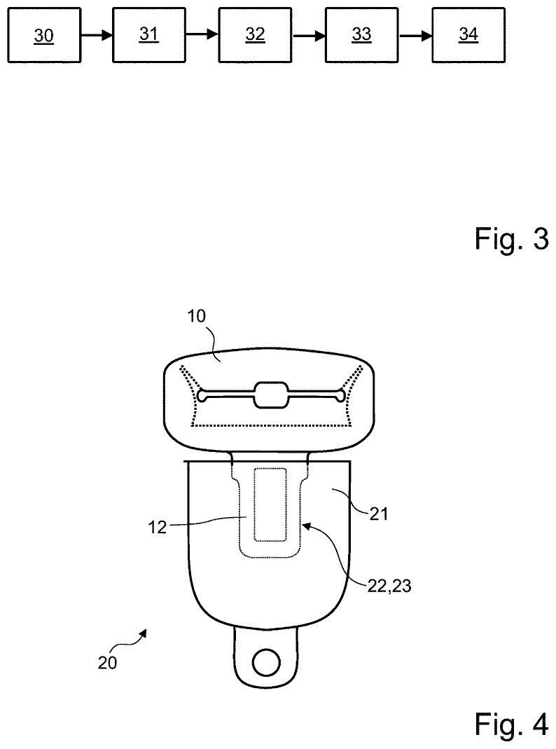

FIG. 3 is a schematic representation of the method steps for the production of a belt tongue with an enamel coating; and

FIG. 4 shows a safety belt system with an enamel-coated belt tongue and a belt buckle.

FIG. 1 shows an advantageous exemplary embodiment of a belt tongue 10 having a main body 11 made of steel. In this advantageous exemplary embodiment, the main body 11 is made of hardenable steel. The main body 11 can, for example, be punched from a sheet metal. The main body 11 can be divided into two portions. First, there is an insertion portion 12 which is intended to be inserted into a belt buckle 21 in order to lock the belt tongue 11 in the belt buckle 21. Adjacent to the insertion portion 12 is a belt fastening portion 13, which is provided for fastening or guiding a safety belt and is not covered by a belt buckle 21 when inserted. The edges 15 of the main body 11 are deburred and preferably rounded. This applies in particular to the insertion portion 12, which is subject to high wear due to the insertion process into a belt buckle 21.

This advantageous belt tongue 10 has an enamel coating 14 in the insertion portion 12 and in the belt fastening portion 13, whereby the surface of the belt tongue 10 in the insertion portion 12 is wear-resistant. The advantageous belt tongue 10 therefore does not require a nickel-chromium coating. In alternative exemplary embodiments, the enamel coating 14 may also be applied only to the insertion portion 12. The enamel coating 14 is preferably less than 50 μm thick, for example 25 μm thick. Furthermore, the enamel coating 14 is black in this exemplary embodiment, but other colors of the enamel coating 14 are also possible.

The main body 11 of the belt tongue 10 is preferably made of hardened steel, so that the belt tongue 10 meets the breaking load requirements and the surface of the main body has a high hardness as a substrate for the enamel coating 14.

In a particularly advantageous exemplary embodiment, the main body 11, which is made of hardenable steel, for example C60, has a bainite structure, which is particularly advantageous for wear resistance during insertion and removal processes and for toughness and strength in a restraint situation.

In an advantageous exemplary embodiment, the enamel coating 14 contains friction-reducing additives, which can further increase the wear resistance of the belt tongue 10.

FIG. 2 shows the exemplary embodiment of the belt tongue 10 provided with an enamel coating 14, the insertion portion 12 being overmolded with a plastics body 16. In this exemplary embodiment, the enamel coating 14 from the belt fastening portion 13 is covered by the plastics body 16.

FIG. 3 schematically shows the method sequence for producing a belt tongue 10. In a first method step 30, the main body 11 of the belt tongue 10 is made of steel, preferably a hardenable steel, for example, C60. The material of the main body 11 in method step 30 is unhardened in this advan-tageous exemplary embodiment. The edges 15 of the belt tongue 10 are deburred, in particular in the insertion portion 12, and rounded in advantageous exemplary embodiments.

In the following method step 31, the enamel paste or enamel slurry is applied to the main body 11. The enamel paste is applied at least to the insertion portion 12 of the belt tongue 10, but it can also be applied additionally to the belt fastening portion 13.

In the following method step 32, the enamel paste is dried; for this purpose, the main body 11 is heated with the enamel paste. In this exemplary embodiment, heating takes place to a temperature of 850° C. and is preferably carried out under a protective gas atmosphere. Method step 32 proceeds to method step 33, where, as a result of the temperature influence, an enamel coating 14 forms from the enamel paste on the main body 11 of the belt tongue 10. Furthermore, in this advantageous exemplary embodiment, the steel of the main body 11 assumes an austenitic structure in method step 33.

In the subsequent method step 34, the main body 11 with the enamel coating 14 is quenched in a salt bath to a temperature between 250° C. and 400° C. This thermally prestresses the enamel coating 14 and hardens the steel of the main body 11. Furthermore, the formation of a bainitic structure in the main body 11 can be achieved by quenching the belt tongue 10 to this temperature, which can also be referred to as intermediate hardening. The surface treatment of the belt tongue 10 is thus completed, so that the production of the enamel coating 14 and the hardening of the main body 11 can be completed in a single operation. Any method steps for coating with a nickel-chromium coating, such as low-hydrogen annealing, can therefore be omitted.

FIG. 4 schematically shows an exemplary embodiment of a safety belt system 20, which comprises a belt tongue 10 and an associated belt buckle 21. The belt buckle 21 has a wear layer 23 having zinc particles in a plastics matrix in the contact region 22 for the insertion portion 12 of the belt tongue 10, which prevents direct contact between the enameled belt tongue 10 and the steel parts of the belt buckle 21, so that this wear layer 23 serves as wear protection for the insertion portion 21 of the belt tongue 10. The wear layer 23 has a lower hardness than the enamel coating 14 and therefore wears faster when both come into contact. In order to adapt to the enamel coating 14 of the belt tongue 10, which in principle has a lower hardness than con-ventional nickel-chromium coatings, the wear layer 23 is made particularly thick, significantly increasing the durability of the wear layer 23.

1. A belt tongue for a safety belt, the belt tongue having a main body made of metal, in particular steel, the main body having an insertion portion and a belt fastening portion, wherein the main body has an enamel coating at least in the insertion portion.

2. The belt tongue according to claim 1, wherein
the main body has rounded edges at least in the insertion portion.

3. The belt tongue according to claim 1, wherein
the enamel coating is prestressed with residual stresses.

4. The belt tongue according to claim 1, wherein
the main body is made of hardened steel.

5. The belt tongue according to claim 1, wherein
the main body has a bainite structure at least on the surface beneath the enamel coating.

6. The belt tongue according to claim 1, wherein
the enamel coating has a thickness of less than 50 μm.

7. The belt tongue according to claim 1, wherein the enamel coating contains friction-reducing additives.

8. The belt tongue according to claim 1, wherein the belt fastening portion of the main body is overmolded with a plastics body.

9. A method for producing a belt tongue according to claim 1, including the steps of:
a) providing a main body of the belt tongue;
b) applying enamel paste to the main body;
c) heating the main body and the enamel paste;
d) forming an enamel coating on the main body;
e) quenching the main body with the enamel coating formed.

10. The method according to claim 9, wherein the heating in step c) takes place under a protective gas atmosphere.

11. The method according to claim 9, wherein the heating in step c) takes place to more than 800° C., preferably to 850° C.

12. The method according to claim 9, wherein the quenching in step e) is carried out in a bath with a temperature between 250° C. and 400° C.

13. The method according to claim 9, wherein the quenching in step e) takes place in a salt bath.

14. The method according to claim 9, wherein, during quenching in step e), the main body is hardened, and a thermal pretension in the enamel coating is brought about.

15. A safety belt system comprising a belt tongue according to claim 1 and a belt buckle, wherein the belt buckle, in the contact region for the insertion portion of a belt tongue, at least partially has a wear layer having zinc particles in a plastics matrix having a thickness of at least 10 μm.
